(19) United States
(12) Patent Application Publication
(10) Pub. No.: US 2025/0109220 A1
(43) Pub. Date: Apr. 3, 2025

(54) Olefin Polymerization Catalyst Comprising Magnesium, Titanium, an Epoxy Compound and an Internal Electron Donor, Such as a 1,2-Phenylene Dibenzoate-Based Compound

(71) Applicant: W.R. Grace & Co.-CONN., Columbia, MD (US)

(72) Inventors: Vladimir P. Marin, Pasadena, TX (US); Ahmed Hintolay, Pasadena, TX (US); Keith G. Hilferding, Sugar Land, TX (US)

(21) Appl. No.: 18/834,958

(22) PCT Filed: Jan. 27, 2023
(86) PCT No.: PCT/US2023/011701

§ 371 Date: Jul. 31, 2024

Related U.S. Application Data
(60) Provisional application No. 63/305,172, filed on Jan. 31, 2022.

(51) Int. Cl. C08F 10/06

(52) U.S. Cl. CPC C08F 10/06; C08F 2410/01

(57) ABSTRACT

A process of preparing a solid catalyst component for olefin polymerization incudes forming a homogenous solution by a reaction of a halide-containing magnesium compound with an epoxy compound in a hydrocarbon solvent; adding at least one non-phthalate internal donor to the homogeneous solution to form a first mixture; treating the first mixture with a first titanium compound to form a solid precipitate; and separating the solid precipitate from the first mixture to form the solid catalyst component.

### CROSS REFERENCE TO RELATED APPLICATIONS

This application claims the benefit of priority to U.S. Provisional Patent Application No. 63/305,172 filed Jan. 31, 2022, which is hereby incorporated by reference, in its entirety for any and all purposes.

### FIELD

The present technology is generally related to polyolefin catalyst systems. More specifically, the technology is related to a solid catalyst component for olefin polymerization, including a halide-containing magnesium, a titanium compound, and an internal electron donor.

### BACKGROUND

Polyolefins are a class of polymers derived from simple olefins. Known methods of making polyolefins involve the use of Ziegler-Natta polymerization catalysts. These catalysts polymerize vinyl monomers using a transition metal halide to provide a polymer with a highly isotactic stereochemical configuration.

Basically, two types of Ziegler-Natta catalyst systems are used in the normal processes for the polymerization or copolymerization of olefins. The first one, in its broadest definition, comprises TiCl₃-based catalyst components, obtained by reduction of TiCl₄ with aluminum alkyls, used in combination with aluminum compounds such as diethylaluminum chloride (DEAC). Despite the modest properties of the polymers in terms of isotacticity the catalysts are characterized by a very low activity which causes the presence of large amounts of catalytic residues in the polymers.

The second type of catalyst system includes a solid precatalyst component, having a magnesium dihalide on which are supported a titanium compound and an internal electron donor compound. In order to maintain the high selectivity for an isotactic polymer product, a variety of internal electron donor compounds must be added during the precatalyst synthesis. Prior the polymerization reaction, the oxidation state of the titanium compound is reduced in presence of an aluminium alkyl to form the catalyst. Conventionally, when a higher crystallinity of the polymer is required, an external donor compound may also be added during the polymerization reaction. Both the internal and external electron donor compounds become important compositions of the catalyst system.

Typically, magnesium Ziegler-Natta catalysts are prepared by mixing a magnesium compound (e.g. MgCl₂) with a halo epoxy compound (e.g. epichlorohydrin) to form a solution (e.g. see U.S. Pat. Nos. 9,593,182 and 8,344,079). To this solution is added a titanium species (e.g. TiCl₄) followed by the addition of an internal donor to form a solid catalyst component. However, this process tends to result in irregularly shaped catalyst particles or powders, which lead to poorly shaped polymers or more difficult to use catalysts. In other words, the resulting morphology of these types of catalysts, and the resulting polymers, is difficult to control. To address this, surface compounds can be added to the magnesium solution, however this tends to lead to powders that can negatively impact commercial polymerization methods. Other methods of forming magnesium-based Ziegler-Natta catalysts are required.

### SUMMARY

In one aspect, a solid catalyst component for olefin polymerization is provided, the solid catalyst component including a halide-containing magnesium, a titanium compound, and an internal electron donor; wherein: the solid catalyst component is prepared from a homogenous reaction mixture containing a halide-containing magnesium, an epoxy compound, and the internal electron donor, wherein a titanium halide is added to the mixture to form the solid catalyst component. The halide-containing magnesium may be represented as: Mg(OR′)ₓX′₂₋ₓ, where each R′ is independently C₁-C₂₀ alkyl optionally substituted with a halogen or a C₃-C₂₀ cycloalkyl alkyl optionally substituted with a halogen; X′ is Br, Cl, or I; x is 0, 1 or 2; the internal electron donor is a non-phthalate internal electron donor; the internal electron donor is present from about 3 wt % to about 25 wt % based upon the total solids weight of the solid catalyst component; the titanium compound is represented by: Ti(OR)_{g}X_{4-g}, where each R is independently a C₁-C₂₀ alkyl, a C₃-C₂₀ cycloalkyl, or a C₆-C₃₀ aryl; X is Br, Cl, or I; g is 0, 1, 2, 3, or 4; the titanium is present from 1 wt % to about 6 wt % based upon the total solids weight of the solid catalyst component; and the solid catalyst component has a particle size from about 3 microns to about 100 microns (on a 50% by volume basis).

In another aspect, a process of preparing a solid catalyst component for olefin polymerization is provided, the process including: forming a homogenous solution by a reaction of a halide-containing magnesium compound with an epoxy compound in a hydrocarbon solvent; contacting at least one an internal donor with the homogeneous solution to form a first mixture; treating the first mixture with a first titanium compound to form a solid precipitate; and separating the solid precipitate from the first mixture to form the solid catalyst component.

In another aspect, a catalyst system for use in olefinic polymerization is provided, the catalyst system including the solid catalyst component produced by the process as described herein, an organoaluminum compound, and optionally, an organosilicon compound and/or organic external donor compound comprising an oxygen or a nitrogen atom.

In another aspect, a process for polymerizing or copolymerizing an olefinic monomer is provided, the process including contacting an olefinic monomer with the catalyst component as described herein, to form a polyolefin polymer in the presence of an organoaluminum compound and at least one selectivity control agent comprising a silane compound alone or in combination with an activity limiting agent.

### BRIEF DESCRIPTION OF THE DRAWINGS

FIG. 1 provides a SEM image of the polymer particles produced in Example 1.

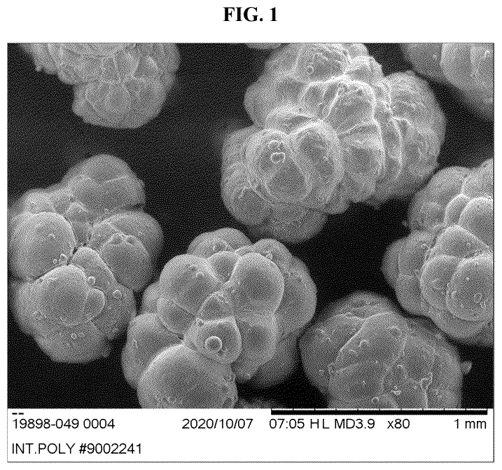

FIG. 2 provides an optical image of the polymer produced in Example 6.

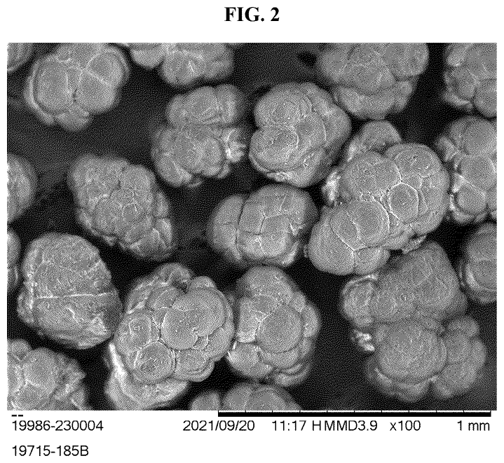

FIG. 3 provides a SEM image of the polymer produced in Example 9.

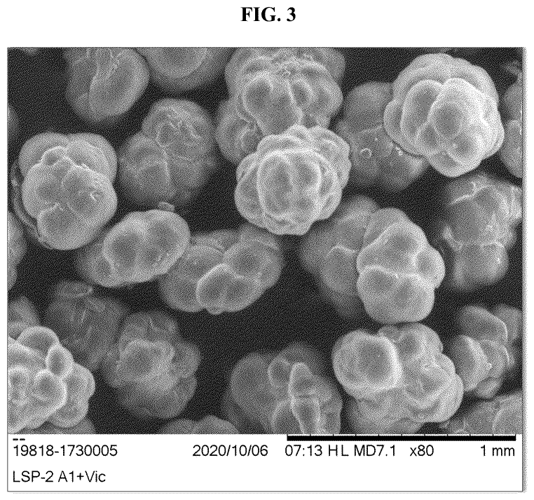

FIG. 4 provides a SEM image of the PP polymer produced in Example 14 (Comparative).

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and may be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, “substituted” refers to an alkyl, alkenyl, aryl, or ether group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

As used herein, “alkyl” groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Alkyl groups may be substituted or unsubstituted. An alkyl group may be substituted one or more times. An alkyl group may be substituted two or more times. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, isopentyl groups, and 1-cyclopentyl-4-methylpentyl. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In some embodiments, haloalkyl refers to a per-haloalkyl group.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbornyl or cycloheptyl groups, which may be substituted with, for example, alkyl, alkoxy, amino, thio, hydroxy, cyano, and/or halo groups.

Alkenyl groups are straight chain, branched or cyclic alkyl groups having 2 to about 20 carbon atoms, and further including at least one double bond. In some embodiments alkenyl groups have from 1 to 12 carbons, or, typically, from 1 to 8 carbon atoms. Alkenyl groups may be substituted or unsubstituted. Alkenyl groups include, for instance, vinyl, propenyl, 2-butenyl, 3-butenyl, isobutenyl, cyclohexenyl, cyclopentenyl, cyclohexadienyl, butadienyl, pentadienyl, and hexadienyl groups among others. Alkenyl groups may be substituted similarly to alkyl groups. Divalent alkenyl groups, i.e., alkenyl groups with two points of attachment, include, but are not limited to, CH—CH═CH₂, C═CH₂, or C═CHCH₃.

As used herein, “aryl”, or “aromatic,” groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. An aryl group with one or more alkyl groups may also be referred to as alkaryl groups. In some embodiments, aryl groups contain 6-14 carbons, and in others from 6 to 12 or even 6-10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be substituted or unsubstituted.

Heterocyclyl or heterocycle refers to both aromatic and nonaromatic ring compounds including monocyclic, bicyclic, and polycyclic ring compounds containing 3 or more ring members of which one or more is a heteroatom such as, but not limited to, N, O, and S. Examples of heterocyclyl groups include, but are not limited to: unsaturated 3 to 8 membered rings containing 1 to 4 nitrogen atoms such as, but not limited to pyrrolyl, pyrrolinyl, imidazolyl, pyrazolyl, pyridinyl, dihydropyridinyl, pyrimidinyl, pyrazinyl, pyridazinyl, triazolyl (e.g. 4H-1,2,4-triazolyl, 1H-1,2,3-triazolyl, 2H-1,2,3-triazolyl etc.), tetrazolyl, (e.g. 1H-tetrazolyl, 2H tetrazolyl, etc.); saturated 3 to 8 membered rings containing 1 to 4 nitrogen atoms such as, but not limited to, pyrrolidinyl, imidazolidinyl, piperidinyl, piperazinyl; condensed unsaturated heterocyclic groups containing 1 to 4 nitrogen atoms such as, but not limited to, indolyl, isoindolyl, indolinyl, indolizinyl, benzimidazolyl, quinolyl, isoquinolyl, indazolyl, benzotriazolyl; unsaturated 3 to 8 membered rings containing 1 to 2 oxygen atoms and 1 to 3 nitrogen atoms such as, but not limited to, oxazolyl, isoxazolyl, oxadiazolyl (e.g. 1,2,4-oxadiazolyl, 1,3,4-oxadiazolyl, 1,2,5-oxadiazolyl, etc.); saturated 3 to 8 membered rings containing 1 to 2 oxygen atoms and 1 to 3 nitrogen atoms such as, but not limited to, morpholinyl; unsaturated condensed heterocyclic groups containing 1 to 2 oxygen atoms and 1 to 3 nitrogen atoms, for example, benzoxazolyl, benzoxadiazolyl, benzoxazinyl (e.g. 2H-1,4-benzoxazinyl etc.); unsaturated 3 to 8 membered rings containing 1 to 3 sulfur atoms and 1 to 3 nitrogen atoms such as, but not limited to, thiazolyl, isothiazolyl, thiadiazolyl (e.g. 1,2,3-thiadiazolyl, 1,2,4-thiadiazolyl, 1,3,4-thiadiazolyl, 1,2,5-thiadiazolyl, etc.); saturated 3 to 8 membered rings containing 1 to 2 sulfur atoms and 1 to 3 nitrogen atoms such as, but not limited to, thiazolodinyl; saturated and unsaturated 3 to 8 membered rings containing 1 to 2 sulfur atoms such as, but not limited to, thienyl, dihydrodithiinyl, dihydrodithionyl, tetrahydrothiophene, tetrahydrothiopyran; unsaturated condensed heterocyclic rings containing 1 to 2 sulfur atoms and 1 to 3 nitrogen atoms such as, but not limited to, benzothiazolyl, benzothiadiazolyl, benzothiazinyl (e.g. 2H-1,4-benzothiazinyl, etc.), dihydrobenzothiazinyl (e.g. 2H-3,4-dihydrobenzothiazinyl, etc.), unsaturated 3 to 8 membered rings containing oxygen atoms such as, but not limited to furyl; unsaturated condensed heterocyclic rings containing 1 to 2 oxygen atoms such as benzodioxolyl (e.g., 1,3-benzodioxoyl, etc.); unsaturated 3 to 8 membered rings containing an oxygen atom and 1 to 2 sulfur atoms such as, but not limited to, dihydrooxathiinyl; saturated 3 to 8 membered rings containing 1 to 2 oxygen atoms and 1 to 2 sulfur atoms such as 1,4-oxathiane; unsaturated condensed rings containing 1 to 2 sulfur atoms such as benzothienyl, benzodithiinyl; and unsaturated condensed heterocyclic rings containing an oxygen atom and 1 to 2 oxygen atoms such as benzoxathiinyl. Heterocyclyl group also include those described above in which one or more S atoms in the ring is double-bonded to one or two oxygen atoms (sulfoxides and sulfones). For example, heterocyclyl groups include tetrahydrothiophene oxide and tetrahydrothiophene 1,1-dioxide. Typical heterocyclyl groups contain 5 or 6 ring members. Thus, for example, heterocyclyl groups include morpholinyl, piperazinyl, piperidinyl, pyrrolidinyl, imidazolyl, pyrazolyl, 1,2,3-triazolyl, 1,2,4-triazolyl, tetrazolyl, thiophenyl, thiomorpholinyl, thiomorpholinyl in which the S atom of the thiomorpholinyl is bonded to one or more O atoms, pyrrolyl, pyridinyl homopiperazinyl, oxazolidin-2-onyl, pyrrolidin-2-onyl, oxazolyl, quinuclidinyl, thiazolyl, isoxazolyl, furanyl, dibenzylfuranyl, and tetrahydrofuranyl. Heterocyclyl or heterocycles may be substituted.

Heteroaryl groups are aromatic ring compounds containing 5 or more ring members, of which, one or more is a heteroatom such as, but not limited to, N, O, and S. Heteroaryl groups include, but are not limited to, groups such as pyrrolyl, pyrazolyl, triazolyl, tetrazolyl, oxazolyl, isoxazolyl, thiazolyl, pyridinyl, pyridazinyl, pyrimidinyl, pyrazinyl, thiophenyl, benzothiophenyl, furanyl, benzofuranyl, dibenzofuranyl, indolyl, azaindolyl (pyrrolopyridinyl), indazolyl, benzimidazolyl, imidazopyridinyl (azabenzimidazolyl), pyrazolopyridinyl, triazolopyridinyl, benzotriazolyl, benzoxazolyl, benzothiazolyl, benzothiadiazolyl, imidazopyridinyl, isoxazolopyridinyl, thianaphthyl, purinyl, xanthinyl, adeninyl, guaninyl, quinolinyl, isoquinolinyl, tetrahydroquinolinyl, quinoxalinyl, and quinazolinyl groups. Heteroaryl groups include fused ring compounds in which all rings are aromatic such as indolyl groups and include fused ring compounds in which only one of the rings is aromatic, such as 2,3-dihydro indolyl groups. Although the phrase “heteroaryl groups” includes fused ring compounds, the phrase does not include heteroaryl groups that have other groups bonded to one of the ring members, such as alkyl groups. Rather, heteroaryl groups with such substitution are referred to as “substituted heteroaryl groups.” Representative substituted heteroaryl groups may be substituted one or more times with various substituents such as those listed above.

As used herein, the prefix “halo” refers to a halogen (i.e. F, Cl, Br, or I) being attached to the group being modified by the “halo” prefix. For example, haloaryls are halogenated aryl groups.

Groups described herein having two or more points of attachment (i.e., divalent, trivalent, or polyvalent) within the compound of the present technology are designated by use of the suffix, “ene.” For example, divalent alkyl groups are alkylene groups, divalent aryl groups are arylene groups, divalent heteroaryl groups are divalent heteroarylene groups, and so forth.

Described herein are methods of preparing solid catalyst systems for olefin polymerization. The methods include incorporation of an internal donor prior to the addition of titanium to a magnesium chloride solution. In the methods, a magnesium compound (e.g. MgCl₂) is dissolved in a solvent mixture comprising an organic epoxy compound, an organic phosphorus compound, and an optional inert diluent to form a homogenous solution. To the homogeneous solution is then added an internal donor (which is also a surface-active compound and structure-directing molecule). Afterward, a titanium species (e.g. TiCl₄) is added to precipitate a solid catalyst component. In subsequent steps or washes, at least one additional internal donor and/or other titanium species may be used, however, the solid catalyst component is suitable for use as-is in many instances. Accordingly, the process described herein is quicker and more economical, and provides improved morphology (catalyst particle size) and catalyst performance (catalyst activity, catalyst tacticity and hydrogen response).

As a general matter, a magnesium-containing solution formed during the reaction of the magnesium compound with the epoxy compound is treated with an internal donor. The electron donor is an organic compound containing an oxygen atom that has the ability to coordinate to the magnesium atom and allow for control of the precipitation process of the solid catalyst component with desired morphology. A combination of organosilicon compounds, acrylatesl, and/or other surfactants in the magnesium-containing solution allow further morphology control morphology of the catalyst components. It is also point out that the magnesium-containing solution may be in the form of a dispersion, a colloid, an emulsions, or other two-phase systems. The homogenous solution can be emulsified using conventional emulsion techniques including one or more of agitation, stirring, mixing, high and/or low shear mixing, mixing nozzles, atomizers, membrane emulsification techniques, milling sonication, vibration, microfluidization, and the like.

In one aspect, a method of forming a solid catalyst component for olefin polymerization is provided. The method incudes forming a homogeneous solution of a halide-containing magnesium compound, an epoxy compound, a phosphorus compound, and a non-phthalate internal electron donor. To the homogeneous solution is then added a titanium halide to form the solid catalyst component. In other words, a process of preparing a solid catalyst component for olefin polymerization includes forming a homogenous solution by a reaction of a halide-containing magnesium compound with an epoxy compound in a hydrocarbon solvent; adding at least one non-phthalate internal donor to the homogeneous solution to form a first mixture; treating the first mixture with a first titanium compound to form a solid precipitate; and separating the solid precipitate from the first mixture to form the solid catalyst component. In some embodiments, the treating with a first titanium compound further includes treating with a further internal donor that may be a non-phthalate internal donor or a convention donor. In some embodiments, the treating further comprises treating the solid precipitate with a second titanium compound to form the solid catalyst component. In further embodiments, the treating further comprises treating the solid precipitate with a second titanium compound and a second internal electron donor to form the solid catalyst component.

During addition of the first titanium halide compound to the magnesium solution that contains associated molecules or groups of molecules of the magnesium compound with coordinated organic compounds in the solution, a reaction occurs between the magnesium compound in the solution and the titanium halide compound forming the magnesium halide and with complexes of the magnesium halide with titanium halide compound and the titanium alkoxide. At the start of this reaction (usually at low temperature; i.e. −35 to −20° C.) the new formed associated groups of the magnesium halide molecules and complexes of the magnesium halide with titanium halide compound are present as “oil phase-droplets” (higher viscosity liquid than other media (solvent) around). During the reaction, the temperature is raised to 0-40° C., where the magnesium halide molecules and complexes of the magnesium halide with titanium halide compound and the titanium alkoxide in the oil phase are crystallized. The crystallization process is usually completed at temperature of 50-100° C., thereby forming the solid the catalyst component.

The morphology of the solid catalyst component (i.e. as measured by particle size and shape) depends on many factors including the polarity of solvent, presence of reagents to control precipitation, surfactants, additives, and others. In particular, the size and shape of droplets formed in the magnesium phase can be controlled through a combination of temperature adjustment, amount of solvent, agitation energy, and including (or excluding) various additives, including the surface modifier and temperature of the precipitation.

The type of internal donor used in the precipitation process also effects the catalyst component morphology. The catalyst component morphology and catalyst performance are sufficiently controlled by addition of the electron donor. The electron donor controls the precipitation process and catalyst component morphology and is incorporated in the catalyst component. Therefore, the electron donor defines also the catalyst performance in polymerization process.

A granular catalyst component morphology can be prepared with a raspberry (i.e. drupelet) shape, a rounded raspberry shape, a rounded shape, and a substantially spherical shape by variation of internal donor or additives added to the process. Di-(C₁-C₁₂)-alkylethers with a combination of acrylates (i.e. surface modifiers) may be used with the internal donors to prepare the spherical type catalyst component. After formation, the magnesium-containing solution can be optionally treated with a halogenating agent. The halogenating agent can be an organic or inorganic compound containing at least one halogen atom that can be transfer able to a magnesium atom. In particular embodiments, the halogenating agent contains chlorine. In particular embodiments, the halogenating agent is selected from aryloyl chlorides, alkanoyl chlorides, and alkyl chlorides. In certain embodiments, the halogenating agent is selected from benzoyl chloride, furoyl chloride, acetyl chloride, linear or branched (C₂-C₆) alkyl chloride, and (C₂-C₆)alkanoyl chlorides. In other embodiments, the halogenating agent is selected from aryloyl chlorides, alkanoyl chlorides, and alkyl chlorides, HCl, TiCl₄, RₙTiCl₄₋ₙ, CCl₄, RₙSiC1₄₋ₙ, and RₙA1C1₃₋ₙ, wherein R represents an alkyl, cycloalkyl, aromatic, or alkoxy, and n is a whole number satisfying the formula 0<n<4, and a ratio of halogenating agent to magnesium compound is at least 1:1 on a mol basis.

The magnesium compounds used in the preparation of the solid precatalyst component may include, for example, a magnesium compound having no reducibility. In one embodiment, the magnesium compound having no reducibility is a halogen-containing magnesium compound. Specific examples of the halide-containing magnesium having no reducibility include, but are not limited to, magnesium halides such as magnesium chloride, magnesium bromide, magnesium iodide and magnesium fluoride; alkoxy magnesium halides such as methoxy magnesium chloride, ethoxy magnesium chloride, isopropoxy magnesium chloride, butoxy magnesium chloride and octoxy magnesium chloride; aryloxy magnesium halides such as phenoxy magnesium chloride and methylphenoxy magnesium chloride; alkoxy magnesiums such as ethoxy magnesium, isopropoxy magnesium, butoxy magnesium, n-octoxy magnesium and 2-ethylhexoxy magnesium; aryloxy magnesiums such as phenoxy magnesium and dimethylphenoxy magnesium; and carboxylic acid salts of magnesium such as magnesium laurate and magnesium stearate. These magnesium compounds may be in the liquid or solid state. In some embodiments, the halide-containing magnesium may be represented as Mg(OR′)ₓX′₂₋ₓ; where each R′ is independently a C₁-C₂₀ alkyl optionally substituted with a halogen, or a C₃-C₂₀ cycloalkyl alkyl optionally substituted with a halogen, X′ is Br, Cl, or I, and x is 0, 1 or 2.

As noted above, the internal electron may be a non-phthalate electron donor. For example, the internal electron donor may be represented by the following formula:

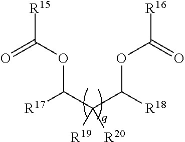

In the formula, each of R¹⁵ through R²⁰ are independently H, a heteroatom, alkyl, cycloalkyl, cycloalkylalkyl, aryl, aralkyl, heterocyclyl, heterocyclylalkyl, heteroaryl, or heteroarylalkyl; and q is an integer from 0 to 12. In some embodiments, each of R¹⁵ through R²⁰ are independently F, Cl, Br, I, NR₂⁴⁶, SiR⁸⁰₃, alkyl, cycloalkyl, cycloalkylalkyl, aryl, aralkyl, heterocyclyl, heterocyclylalkyl, heteroaryl, or heteroarylalkyl; q is an integer from 0 to 12, and each R⁴⁶ is independently selected from H, C₁-C₂₀ alkyl, C₆-C₂₀ aryl or alkylaryl. Each R⁸⁰ is individually alkyl, cycloalkyl, alkoxy, cycloalkylalkyl, aryl, aralkyl, heterocyclyl, heterocyclylalkyl, heteroaryl, or heteroarylalkyl.

As noted above, the solid catalyst component may contain at least one additional internal electron donor. In some embodiments, the at least one additional internal electron donor comprises an aryl diester, a diether, a succinate, an organic acid ester, a polycarboxylic acid ester, a polyhydroxy ester, a heterocyclic polycarboxylic acid ester, a compound having at least one ether group and at least one ketone group, or a mixture of any two more thereof. In some embodiments, the at least one additional internal electron donor comprises an aryl diester, acylated catechol, carbonated catechol, or alkoxyalkyl ether. In some embodiments, the at least one additional internal electron donor comprises an aryl diester.

In some embodiments, the internal electron donor or the least one additional internal electron donor (which may be different from the internal electron donor) may be represented by one of the following formulas:

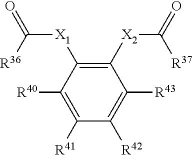

where R⁴⁰-R⁴³, are each independently selected from H, a heteroatom, alkyl, cycloalkyl, cycloalkylalkyl, aryl, aralkyl, alkylaryl, or an —OR⁴⁴ where R⁴⁴ is C₁-C₂₀ alkyl, C₆-C₂₀ aryl, C₆-C₂₀ aralkyl, or C₆-C₂₀ alkylaryl; R³⁶ and R³⁷ are each independently selected from F, Cl, Br, I, alkyl, cycloalkyl, cycloalkylalkyl, aryl, aralkyl, alkylaryl, —OR⁴⁵, or —NR₂⁴⁶; R⁴⁵ is C₁-C₂₀ alkyl, C₆-C₂₀ aryl, or alkylaryl; X₁ and X₂ are each O, S, or NR⁴⁷; and R⁴⁷ is H, C₁-C₂₀ alkyl, C₆-C₂₀ aryl, C₆-C₂₀ aralkyl; or

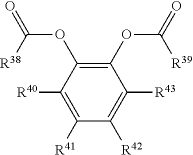

wherein: R³⁸, R³⁹, R⁴⁰, R⁴¹, R⁴², and R⁴³ are each independently H, a heteroatom, alkyl, cycloalkyl, cycloalkylalkyl, aryl, alkylaryl, heterocyclyl, heterocyclylalkyl, heteroaryl, or heteroarylalkyl; or

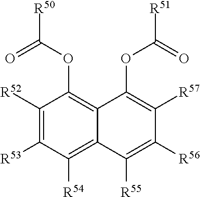

wherein: each of R⁵⁰ through R⁵⁷ are independently H, a heteroatom, alkyl, cycloalkyl, cycloalkylalkyl, aryl, aralkyl, heterocyclyl, heterocyclylalkyl, heteroaryl, or heteroarylalkyl. The internal electron donor may be present from about 3 wt % to about 25 wt % based upon the total solids weight of the solid catalyst component.

As noted above, the homogeneous solution includes an epoxy compound. The epoxy compounds may include compounds having at least one epoxy group in the form of a monomers, a dimer, an oligomer, or a polymer. Examples of epoxy compounds may include, but are not limited to, aliphatic epoxy compounds, alicyclic epoxy compounds, aromatic epoxy compounds, or the like. Examples of aliphatic epoxy compounds may include, but are not limited to, halogenated aliphatic epoxy compounds, aliphatic epoxy compounds having a keto group, aliphatic epoxy compounds having an ether bond, aliphatic epoxy compounds having an ester bond, aliphatic epoxy compounds having a tertiary amino group, aliphatic epoxy compounds having a cyano group, or the like. Examples of cyclic epoxy compounds may include, but are not limited to, halogenated alicyclic epoxy compounds, alicyclic epoxy compounds having a keto group, alicyclic epoxy compounds having an ether bond, alicyclic epoxy compounds having an ester bond, alicyclic epoxy compounds having a tertiary amino group, alicyclic epoxy compounds having a cyano group, or the like. Examples of aromatic epoxy compounds may include, but are not limited to, halogenated aromatic epoxy compounds, aromatic epoxy compounds having a keto group, aromatic epoxy compounds having an ether bond, aromatic epoxy compounds having an ester bond, aromatic epoxy compounds having a tertiary amino group, aromatic epoxy compounds having a cyano group, or the like.

Illustrative epoxy compounds may be a glycidyl-containing compound represented by Formula:

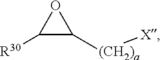

wherein: a is 1, 2, 3, 4, or 5; X″ is alkyl, F, Cl, Br, or I; and R³¹ is alkyl, aryl, or cyclyl. In some embodiments, X″ is methyl, ethyl, F, Cl, Br, or I.

Specific examples of epoxy compounds may include, but are not limited to, epifluorohydrin, epichlorohydrin, epibromohydrin, hexafluoropropylene oxide, 1,2-epoxy-4-fluorobutane, 1-(2,3-epoxypropyl)-4-fluorobenzene, 1-(3,4-epoxybutyl)-2-fluorobenzene, epoxypropyl)-4-chlorobenzene, 1-(3,4-epoxybutyl)-3-chlorobenzene, or the like. Specific examples of halogenated alicyclic epoxy compounds include 4-fluoro-1,2-cyclohexene oxide, 6-chloro-2,3 epoxybicyclo[2,2,1]heptane, or the like. Specific examples of halogenated aromatic epoxy compounds may include 4-fluorostyrene oxide, 1-(1,2-epoxypropyl)-3-trifluorobenzene, or the like.

In some embodiments, the reaction mixture may include an organic phosphorus compound. In some embodiments, the organic phosphorus compound is represented by:

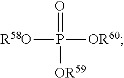

wherein: R⁵⁸, R⁵⁹, and R⁶⁰ are each independently C₁-C₁₀ alkyl. Illustrative organic phosphorus compounds may include, but are not limited to, trimethyl phosphate, triethyl phosphate, tributyl phosphate, triphenyl phosphate, trimethyl phosphite, triethyl phosphite, tributyl phosphite and triphenyl phosphite.

The homogenous solution may also optionally contain an organosilicon compound as a surfactant. The organosilicon compound may contain silicon having at least one hydrogen ligand (hydrocarbon group). General examples of hydrocarbon groups include alkyl groups, cycloalkyl groups, (cycloalkyl)methylene groups, alkene groups, aromatic groups, and the like.

In one embodiment, the organosilicon compound is represented as Formula (IV):

RₙSi(OR′)₄₋ₙ (IV).

In Formula (IV), each R and R′ is independently represent a hydrocarbon group, and n is 0≤n≤4. In other embodiments, the organosilane is a silane or a polysiloxane.

Specific examples of the organosilicon compound of formula (IV) include, but are not limited to trimethylmethoxysilane, trimethylethoxysilane, dimethyldimethoxysilane, dimethyldiethoxysilane, diisopropyldimethoxysilane, diisobutyldimethoxysilane, t-butylmethyldimethoxysilane, t-butylmethyldiethoxysilane, t-amylmethyldiethoxysilane, dicyclopentyldimethoxysilane, diphenyldimethoxysilane, phenylmethyldimethoxysilane, diphenyldiethoxysilane, bis-o-tolydimethoxysilane, bis-m-tolydimethoxysilane, bis-p-tolydimethoxysilane, bis-p-tolydiethoxysilane, bisethylphenyldimethoxysilane, dicyclohexyldimethoxysilane, cyclohexylmethyldimethoxysilane, cyclohexylmethyldiethoxysilane, ethyltrimethoxysilane, ethyltriethoxysilane, vinyltrimethoxysilane, methyltrimethoxysilane, n-propyltriethoxysilane, decyltrimethoxysilane, decyltriethoxysilane, phenyltrimethoxysilane, gamma-chloropropyltrimethoxysilane, methyltriethoxysilane, ethyltriethoxysilane, vinyltriethoxysilane, t-butyltriethoxysilane, nbutyltriethoxysilane, iso-butyltriethoxysilane, phenyltriethoxysilane, gammaamniopropyltriethoxysilane, cholotriethoxysilane, ethyltriisopropoxysilane, vinyltirbutoxysilane, cyclohexyltrimethoxysilane, cyclohexyltriethoxysilane, 2-norbornanetrimethoxysilane, 2-norboranetriethoxysilane, 2-norboranemethyldimethoxysilane, ethyl silicate, butyl silicate, trimethylphenoxysilane, and methyltriallyloxysilane.

In another embodiment, the organosilicon compound is represented by Formula (V):

SiRR′ₘ(OR″)₃₋ₘ (V).

In Formula (V), 0≤m<3, such as 0≤m<2; and R independently represents a cyclic hydrocarbon or substituted cyclic hydrocarbon group. Specific examples of the group R include, but are not limited to cyclopropyl; cyclobutyl; cyclopentyl; 2-methylcyclopentyl; 3-methylcyclopentyl; 2-ethylcyclopentyl; 3-propylcyclopentyl; 3-isopropylcyclopentyl; 3-butylcyclopentyl; 3-tetiary butyl cyclopentyl; 2,2-dimethylcyclopentyl; 2,3-dimethylcyclopentyl; 2,5-dimethylcyclopentyl; 2,2,5-trimethylcyclopentyl; 2,3,4,5-tetramethylcyclopentyl; 2,2,5,5-tetramethylcyclopentyl; 1-cyclopentylpropyl; 1-methyl-1-cyclopentylethyl; cyclopentenyl; 2-cyclopentenyl; 3-cyclopentenyl; 2-methyl-1-cyclopentenyl; 2-methyl-3-cyclopentenyl; 3-methyl-3-cyclopentenyl; 2-ethyl-3-cyclopentenyl; 2,2-dimethyl-3-cyclopentenyl; 2,5-dimethyl-3-cyclopentenyl; 2,3,4,5-tetramethyl-3-cyclopentenyl; 2,2,5,5-tetramethyl-3-cyclopentenyl; 1,3-cyclopentadienyl; 2,4-cyclopentadienyl; 1,4-cyclopentadienyl; 2-methyl-1,3-cyclopentadienyl; 2-methyl-2,4-cyclopentadienyl; 3-methyl-2,4-cyclopentadienyl; 2-ethyl-2,4-cyclopentadienyl; 2,2-dimethyl-2,4-cyclopentadienyl; 2,3-dimethyl-2,4-cyclopentadienyl; 2,5-dimethyl-2,4-cyclopentadienyl; 2,3,4,5-tetramethyl-2,4-cyclopentadienyl; indenyl; 2-methylindenyl; 2-ethylindenyl; 2-indenyl; 1-methyl-2-indenyl; 1,3-dimethyl-2-indenyl; indanyl; 2-methylindanyl; 2-indanyl; 1,3-dimethyl-2-indanyl; 4,5,6,7-tetrahydroindenyl; 4,5,6,7-tetrahydro-2-indenyl; 4,5,6,7-tetrahydro-1-methyl-2-indenyl; 4,5,6,7-tetrahydro-1,3-dimethyl-2-indenyl; fluorenyl groups; cyclohexyl; methylcyclohexyls; ethylcylcohexyls; propylcyclohexyls; isopropylcyclohexyls; n-butylcyclohexyls; tertiary-butyl cyclohexyls; dimethylcyclohexyls; and trimethylcyclohexyls.

In formula (V), R′ and R″ are identical or different and each represents a hydrocarbon. Examples of R′ and R″ are alkyl, cycloalkyl, aryl and aralkyl groups having 3 or more carbon atoms. Furthermore, R and R′ may be bridged by an alkyl group, etc. General examples of organosilicon compounds are those of formula (V) in which R is cyclopentyl group, R′ is an alkyl group such as methyl or cyclopentyl group, and R″ is an alkyl group, particularly a methyl or ethyl group.

Specific examples of organosilicon compounds of Formula (V) include, but are not limited to trialkoxysilanes such as cyclopropyltrimethoxysilane, cyclobutyltrimethoxysilane, cyclopentyltrimethoxysilane, 2-methylcyclopentyltrimethoxysilane, 2,3-dimethylcyclopentyltrimethoxysilane, 2,5-dimethylcyclopentyltrimethoxysilane, cyclopentyltriethoxysilane, cyclopentenyltrimethoxysilane, 3-cyclopentenyltrimethoxysilane, 2,4-cyclopentadienyltrimethoxysilane, indenyltrimethoxysilane and fluorenyltrimethoxysilane; dialkoxysilanes such as dicyclopentyldimethoxysilane, bis(2-methylcyclopentyl)dimethoxysilane, bis(3-tertiary butylcyclopentyl)dimethoxysilane, bis(2,3-dimethylcyclopentyl)dimethoxysilane, bis(2,5-dimethylcyclopentyl)dimethoxysilane, dicyclopentyldiethoxysilane, dicyclobutyldiethoxysilane, cyclopropylcyclobutyldiethoxysilane, dicyclopentenyldimethoxysilane, di(3-cyclopentenyl)dimethoxysilane, bis(2,5-dimethyl-3-cyclopentenyl)dimethoxysilane, di-2,4-cyclopentadienyl)dimethoxysilane, bis(2,5-dimethyl-2,4-cyclopentadienyl)dimethoxysilane, bis(1-methyl-1-cyclopentylethyl)dimethoxysilane, cyclopentylcyclopentenyldimethoxysilane, cyclopentylcyclopentadienyldimethoxysilane, diindenyldimethoxysilane, bis(1,3-dimethyl-2-indenyl)dimethoxysilane, cyclopentadienylindenyldimethoxysilane, difluorenyldimethoxysilane, cyclopentylfluorenyldimethoxysilane and indenylfluorenyldimethoxysilane; monoalkoxysilanes such as tricyclopentylmethoxysilane, tricyclopentenylmethoxysilane, tricyclopentadienylmethoxysilane, tricyclopentylethoxysilane, dicyclopentylmethylmethoxysilane, dicyclopentylethylmethoxysilane, dicyclopentylmethylethoxysilane, cyclopentyldimethylmethoxysilane, cyclopentyldiethylmethoxysilane, cyclopentyldimethylethoxysilane, bis(2,5-dimethy lcyclopentyl)cyclopentylmethoxysilane, dicyclopentyl cyclopentenylmethoxysilane, dicyclopentylcyclopentenadienylmethoxysilane and diindenylcyclopentylmethoxysilane; and ethylenebis-cyclopentyldimethoxysilane.

With regard to the solvent in which the homogeneous solution is formed, suitable solvents include, but are not limited to, a hydrocarbon or halogenated hydrocarbon solvent. In some embodiments, the hydrocarbon solvent is an aromatic or aliphatic hydrocarbon. In further embodiments, the hydrocarbon solvent is selected from the group consisting of toluene, ethyl benzene, pentane, hexane, and heptane. In specific embodiments, solvent further comprises a siloxane solvent. In further specific embodiments, the siloxane solvent is dimethylpolysiloxane.

To sufficiently dissolve a magnesium compound, an inert diluent may be added to the solvent mixture. The inert diluent can typically be aromatic hydrocarbons or alkanes, as long as it can facilitate the dissolution of the magnesium compound. Examples of aromatic hydrocarbons include, but are not limited to, benzene, toluene, xylene, chlorobenzene, dichlorobenzene, trichlorobenzene, chlorotoluene, and derivatives thereof. Examples of alkanes include linear, branched, or cyclic alkanes having about 3 to about 30 carbons, such as butane, pentane, hexane, cyclohexane, heptanes, and the like. These inert diluents may be used alone or in combination.

In some embodiments, the titanium compound(s) used in the method are the same or different and represented by: Ti(OR)_{g}X_{4-g}; wherein: each R is independently a C₁-C₂₀ alkyl, a C₃-C₂₀ cycloalkyl, or C₆-C₃₀ aryl; X is Br, Cl, or I; and g is 0, 1, 2, 3, or 4. The titanium is present from 1 wt % to about 6 wt % based upon the total solids weight of the solid catalyst component. A preferred titanium compound is TiCl₄.

In some embodiments, the treating is conducted at a temperature from −35° C. to 30° C. during addition of the first titanium compound and wherein the temperature after completion of addition is from 30° C. to 150° C.

In some embodiments, the solid catalyst component formed in the method has a particle size from about 3 microns to about 100 microns (on a 50% by volume basis). In some embodiments, the solid catalyst component contains at least one additional internal electron donor.

In some embodiments, the nonphthalate internal electron donor is represented as a compound of formula:

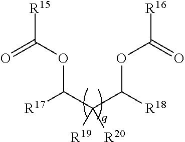

In this formula, each of R¹⁵ through R²⁰ are independently H, a heteroatom, alkyl, cycloalkyl, cycloalkylalkyl, aryl, aralkyl, heterocyclyl, heterocyclylalkyl, heteroaryl, or heteroarylalkyl; and q is an integer from 0 to 12. In some embodiments, each of R¹⁵ through R²⁰ are independently F, Cl, Br, I, NR₂⁴⁶, SiR⁸⁰₃, alkyl, cycloalkyl, cycloalkylalkyl, aryl, aralkyl, heterocyclyl, heterocyclylalkyl, heteroaryl, or heteroarylalkyl; q is an integer from 0 to 12, and each R⁴⁶ is independently selected from H, C₁-C₂₀ alkyl, C₆-C₂₀ aryl or alkylaryl. Each R⁸⁰ is individually alkyl, cycloalkyl, alkoxy, cycloalkylalkyl, aryl, aralkyl, heterocyclyl, heterocyclylalkyl, heteroaryl, or heteroarylalkyl.

In some embodiments, the nonphthalate internal electron donor is represented by one of the following formulae:

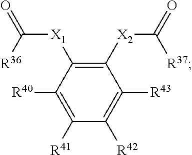

wherein R⁴⁰-R⁴³ are each independently selected from H, a heteroatom, alkyl, cycloalkyl, cycloalkylalkyl, aryl, aralkyl, alkylaryl, or an —OR⁴⁴; where R⁴⁴ is C₁-C₂₀ alkyl, C₆-C₂₀ aryl, C₆-C₂₀ aralkyl, or C₆-C₂₀ alkylaryl; R³⁶ and R³⁷ are each independently selected from F, Cl, Br, I, alkyl, cycloalkyl, cycloalkylalkyl, aryl, aralkyl, alkylaryl, —OR⁴⁵, or —NR₂⁴⁶; R⁴⁵ is C₁-C₂₀ alkyl, C₆-C₂₀ aryl, or alkylaryl; each R⁴⁶ is independently selected from H, C₁-C₂₀ alkyl, C₆-C₂₀ aryl or alkylaryl; X₁ and X₂ are each O, S, or NR⁴⁷; and R⁴⁷ is H, C₁-C₂₀ alkyl, C₆-C₂₀ aryl, C₆-C₂₀ aralkyl; or

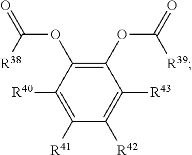

wherein: R³⁸, R³⁹, R⁴⁰, R⁴¹, R⁴², and R⁴³ are each independently H, a heteroatom, alkyl, cycloalkyl, cycloalkylalkyl, aryl, alkylaryl, heterocyclyl, heterocyclylalkyl, heteroaryl, or heteroarylalkyl; or

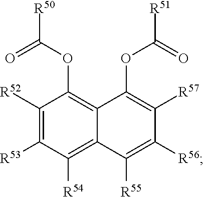

wherein: each of R⁵⁰ through R⁵⁷ are each independently H, a heteroatom, alkyl, cycloalkyl, cycloalkylalkyl, aryl, aralkyl, heterocyclyl, heterocyclylalkyl, heteroaryl, or heteroarylalkyl.

In some embodiments, R⁴⁰-R⁴³ are each independently selected from H, F, Cl, Br, I, heteroatom, NR₂⁴⁶, alkyl, cycloalkyl, cycloalkylalkyl, aryl, aralkyl, alkylaryl, or an —OR⁴⁴; and each R⁴⁶ is independently selected from H, C₁-C₂₀ alkyl, C₆-C₂₀ aryl or alkylaryl. In some embodiments, R³⁸, R³⁹, R⁴⁰, R⁴¹, R⁴², and R⁴³ are each independently H, F, Cl, Br, I, heteroatom, NR₂⁴⁶, alkyl, cycloalkyl, cycloalkylalkyl, aryl, alkylaryl, heterocyclyl, heterocyclylalkyl, heteroaryl, or heteroarylalkyl; and each R⁴⁶ is independently selected from H, C₁-C₂₀ alkyl, C₆-C₂₀ aryl or alkylaryl. In some embodiments, each of R⁵⁰ through R⁵⁷ are each independently H, F, Cl, Br, I, NR₂⁴⁶, SiR⁸⁰₃, alkyl, cycloalkyl, cycloalkylalkyl, aryl, aralkyl, heterocyclyl, heterocyclylalkyl, heteroaryl, or heteroarylalkyl; and each R⁴⁶ is independently selected from H, C₁-C₂₀ alkyl, C₆-C₂₀ aryl or alkylaryl. and each R⁸⁰ is individually alkyl, alkoxy, cycloalkyl, cycloalkylalkyl, aryl, aralkyl, heterocyclyl, heterocyclylalkyl, heteroaryl, or heteroarylalkyl.

Examples of other electron donors include oxygen-containing electron donors such as organic acid esters. Specific examples include, but are not limited to, diethyl ethylmalonate, diethyl propylmalonate, diethyl isopropylmalonate, diethyl butylmalonate, diethyl 1,2-cyclohexanedicarboxylate, di-2-ethylhexyl 1,2-cyclohexanedicarboxylate, di-2-isononyl 1,2-cyclohexanedicarboxylate, methyl benzoate, ethyl benzoate, propyl benzoate, butyl benzoate, octyl benzoate, cyclohexyl benzoate, phenyl benzoate, benzyl benzoate, methyl toluate, ethyl toluate, amyl toluate, ethyl ethylbenzoate, methyl anisate, ethyl anisate, ethyl ethoxybenzoate, diethyl succinate, dipropyl succinate, diisopropyl succinate, dibutyl succinate, diisobutyl succinate, dioctyl succinate, diisononyl succinate, and diether compounds such as 9,9-bis(methoxymethyl)fluorine, 2-isopropyl-2-isopentyl-1,3-dimethoxypropane, 2,2-diisobutyl-1,3-dimethoxypropane, 2,2-diisopentyl-1,3-dimethoxypropane, 2-isopropyl-2-cyclohexyl-1,3-dimethoxypropane.

In one embodiment, when the solid catalyst component is formed, a surfactant may be used. The surfactant may contribute to many of the beneficial properties of the solid catalyst component and catalyst system. General examples of the surface modifier include polymer surfactants, such as polyacrylates, polymethacrylates, polyalkyl methacrylates, or any other surfactant that can stabilize and emulsify. Surfactants are known in the art, and many surfactants are described in McCutcheon's “Volume I. Emulsifiers and Detergents”, 2001, North American Edition, published by Manufacturing Confectioner Publishing Co., Glen Rock, N.J., and in particular, pp. 1-233 which describes a number of surfactants and is hereby incorporated by reference for the disclosure in this regard. A polyalkyl methacrylate is a polymer that may contain one or more methacrylate monomers, such as at least two different methacrylate monomers, at least three different methacrylate monomers, etc. Moreover, the acrylate and methacrylate polymers may contain monomers other than acrylate and methacrylate monomers, so long as the polymer surfactant contains at least about 40% by weight acrylate and methacrylate monomers.

Examples of monomers that can be polymerized using known polymerization techniques into polymer surfactants include one or more of acrylate; tert-butyl acrylate; n-hexyl acrylate; methacrylate; methyl methacrylate; ethyl methacrylate; propyl methacrylate; isopropyl methacrylate; n-butyl methacrylate; t-butyl methacrylate; isobutyl methacrylate; pentyl methacrylate; isoamyl methacrylate; n-hexyl methacrylate; isodecyl methacrylate; lauryl methacrylate; stearyl methacrylate; isooctyl acrylate; lauryl acrylate; stearyl acrylate; cyclohexyl acrylate; cyclohexyl methacrylate; methoxyethyl acrylate; isobenzyl acrylate; isodecyl acrylate; n-dodecyl acrylate; benzyl acrylate; isobornyl acrylate; isobornyl acrylate; isobornyl methacrylate; 2-hydroxyethyl acrylate; 2-hydroxypropyl acrylate; 2-methoxyethyl acrylate; 2-methoxybutyl acrylate; 2-(2-ethoxyethoxy)ethyl acrylate; 2-phenoxyethyl acrylate; tetrahydrofurfuryl acrylate; 2-(2-phenoxyethoxy)ethyl acrylate; methoxylated tripropylene glycol monacrylate; 1,6-hexanediol diacrylate; ethylene glycol dimethacrylate; diethylene glycol dimethacrylate; triethylene glycol dimethacrylate; polyethylene glycol dimethacrylate; butylene glycol dimethacrylate; trimethylolpropane-3-ethoxylate triacrylate; 1,4-butanediol diacrylate; 1,9-nonanediol diacrylate; neopentyl glycol diacrylate; tripropylene glycol diacrylate; tetraethylene glycol diacrylate; heptapropylene glycol diacrylate; trimethylol propane triacrylate; ethoxylated trimethylol propane triacrylate; pentaerythritol triacrylate; trimethylolpropane trimethacrylate; tripropylene glycol diacrylate; pentaerythritol tetraacrylate; glyceryl propoxy triacrylate; tris(acryloyloxyethyl)phosphate; 1-acryloxy-3-methacryloxy glycerol; 2-methacryloxy-N-ethyl morpholine; and allyl methacrylate, and the like.

In certain embodiments, the surface modifier is selected from poly((C₁-C₆) alkyl) acrylate, a poly((C₁-C₆) alkyl) methacrylate, and a copolymer of poly((C₁-C₆) alkyl) acrylate and poly((C₁-C₆) alkyl) methacrylate. In embodiments, a ratio of the surface modifier to halide-containing magnesium compound is from 1:10 to 2:1 wt % or from 1:5 to 1:1 wt %. Examples of polymer surfactants that are commercially available include those under the trade designation VISCOPLEX® available from RohMax Additives, GmbH, including those having product designations 1-254, 1-256 and those under the trade designations CARBOPOL® and PEMULEN® available from Noveon/Lubrizol.

In another aspect, is provided a catalyst system for use in olefinic polymerization, the catalyst system comprising the solid catalyst component produced by the process as described herein, an organoaluminum compound, and optionally, an organosilicon compound or organic external donor compound comprising an oxygen or a nitrogen atom.

In some embodiments, the organoaluminum compound is an alkyl-aluminum compound. In some embodiments, the alkyl-aluminum compound is a trialkyl aluminum compound. In some embodiments, the trialkyl aluminum compound comprises triethylaluminum, triisobutylaluminum, or tri-n-octylaluminum. Illustrative examples of the organoaluminum compounds include, but are not limited to, trialkyl aluminums such as triethyl aluminum, tributyl aluminum and trihexyl aluminum; trialkenyl aluminums such as triisoprenyl aluminum; dialkyl aluminum halides such as diethyl aluminum chloride, dibutyl aluminum chloride and diethyl aluminum bromide; alkyl aluminum sesquihalides such as ethyl aluminum sesquichloride, butyl aluminum sesquichloride and ethyl aluminum sesquibromide; alkyl aluminum dihalides such as ethyl aluminum dichloride, propyl aluminum dichloride and butyl aluminum dibromide; dialkyl aluminum hydrides such as diethyl aluminum hydride and dibutyl aluminum hydride; and other partially hydrogenated alkyl aluminum such as ethyl aluminum dihydride and propyl aluminum dihydride.

The organoaluminum compound may be used in the catalyst system in an amount that the mole ratio of aluminum to titanium (from the solid precatalyst component) is from about 5 to about 1,000. In another embodiment, the mole ratio of aluminum to titanium in the catalyst system may be from about 10 to about 700. In yet another embodiment, the mole ratio of aluminum to titanium in the catalyst system may be from about 25 to about 400.

The catalyst system may contain at least one organosilicon compound in addition to the solid catalyst component that is added after the precipitation of the catalyst by addition of the titanium. This organosilicon compound is sometimes termed as an external electron donor, and it may be any of the organosilicon compounds as described above.

The organosilicon compound, when used as an external electron donor serving as one component of a Ziegler-Natta catalyst system for olefin polymerization, contributes to the ability to obtain a polymer (at least a portion of which is polyolefin) having a controllable molecular weight distribution and controllable crystallinity while retaining high performance with respect to catalytic activity.

The organosilicon compound may be used in the catalyst system as an external donor in an amount such that the mole ratio of the organoaluminum compound to the organosilicon compound is from about 2 to about 90. In another embodiment, the mole ratio of the organoaluminum compound to the organosilicon compound is from about 5 to about 70. In yet another embodiment, the mole ration of the organoaluminum compound to the organosilicon compound is from about 7 to about 35.

In another aspect, is provided a process for polymerizing or copolymerizing an olefinic monomer, the process comprising contacting an olefinic monomer with the catalyst component as described herein, to form a polyolefin polymer in the presence of an organoaluminum compound and at least one selectivity control agent comprising a silane compound alone or in combination with an activity limiting agent.

In some embodiments, the polymerizing or copolymerizing occurs in the presence of at least one selectivity control agent comprising a silane compound alone or in combination with an activity limiting agent.

Without being bound by theory, it is believed that use of the electron donor compound contributes to improved performance characteristics of resultant catalysts, such as high/improved catalyst activity, high/improved hydrogen response, the ability to produce polyolefins with desired/controllable crystallinity measured by polymer fractionation values and ¹³C NMR analysis and desired/controllable molecular weight measured by melt flow indexes and high temperature size exclusion chromatography (HSEC), and the like.

Polymerization of olefins may be carried out in the presence of the catalyst system described above. Generally speaking, olefins are contacted with the catalyst system described above under suitable conditions to form desired polymer products. In one embodiment, preliminary polymerization described below is carried out before the main polymerization. In another embodiment, polymerization is carried out without preliminary polymerization. In yet another embodiment, the formation of copolymer is carried out using at least two polymerization zones.

The present invention, thus generally described, will be understood more readily by reference to the following examples, which are provided by way of illustration and are not intended to be limiting of the present invention.

### Examples

General catalyst preparation. Generally, the process of catalyst component preparation described herein includes dissolving MgCl₂ in a mixture of epichlorohydrin (ECH), tributylphosphate (TBP), and toluene at 60° C. to form a homogenous solution. An internal donor (which is also a surface-active compound and structure directing molecule) is added to the homogeneous solution at room temperature. The mixture is then cooled to −25° C., and TiCl₄ is added. After the completion of the TiCl₄ addition the reaction mixture is heated to 85-110° C. The solid is washed with toluene to form the catalyst component. The catalyst component contains titanium, magnesium, and the internal donor.

General polymerization methods. Where catalysts of the examples are used in a method of propylene polymerization the following is typical. The reactor was cooled to 30-35° C. and co-catalyst (1.5 ml of 25 wt % triethylaluminum (“TEAl”)), a silane (i.e. cyclohexylmethydimethoxysilane; 1 ml), H₂ (10 standard liters (“SL”)), and liquid propylene (1500 ml) were added, in the stated sequence, to the reactor. The catalyst component (5-10 mg), was then loaded into the reactor as a mineral oil slurry, under pressure nitrogen. The polymerization was then performed for one hour at 70° C. After the polymerization, the reactor was cooled to 22° C., vented to atmospheric pressure, and the polymer collected.

Example 1. 3.3 g of MgCl₂, 30 g of toluene, 9.1 g of TBP, 3.55 g of ECH were charged to a reactor. The mixture was heated to 60° C. and held for 8 hours at 600 RPM agitation speed to form a homogenous solution. The mixture was cooled to 25° C., and 28 grams of toluene and 1.125 g of ID1 in 5 g of toluene were added to the reactor. The reactor was cooled to −25° C. and 65.4 grams of TiCl₄ were added to the reactor. The agitation set to 250 RPM and the temperature ramped to 35° C. over 2 hours and then held at temperature for 30 minutes with stirring. The reaction was then heated to 85° C. and held for 30 minutes. The reaction mixture was filtered and the solid collected, washed with hexane three times, and dried. As used in this example, ID1 is 4-cyclohexyl-3,6-dimethyl-1,2-phenylene dibenzoate:

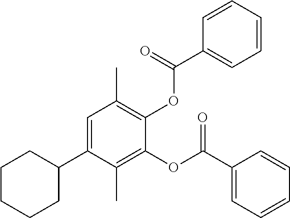 [SMILES: Cc1cc(C2CCCCC2)c(C)c(OC(=O)c2ccccc2)c1OC(=O)c1ccccc1]

The catalyst component showed high catalyst activity (CE=64.2 kg/g) and high bulk density (“BD”) conversion (0.429 g/cc).

Example 2. Example 1 was repeated except the catalyst component was treated with 65 mL of 10% TiCl₄ at 105° C. for 1 hour and at 110° C. for 30 min (3×). The result of this treatment is that the catalyst component activity is increased to 78.6 kg/g.

Example 3. 3.3 g of MgCl₂, 30 g toluene, 9.1 g TBP, and 3.55 g of ECH were charged to a reactor. The mixture was heated at 60° C. for 8 hours at 600 RPM agitation speed. The mixture was cooled to 25° C., and then toluene (22 g) and ID2 (1.125 g in 5 g of toluene) were added to the reactor. The reaction was then cooled to −25° C. and TiCl₄ (65.4 g) was added to the reactor with an agitation speed of 600 rpm. The reaction mixture was then heated to 35° C. in over 2 hours with an agitation speed of 250 rpm, where it was held at temperature for 30 minutes, followed by hearing to 85° C. and a 30 minute temperature hold. The solid precipitate was collected by filtration and washed with toluene (50 ml) three times. The solid precipitate was treated with 65 mL of 10% TiCl₄ in toluene at 105° C. for 1 hour and with 65 mL of 10% TiCl₄ in toluene at 110° C. for 30 min (three times). The final solid was washed with hexane (three times) and dried. In this example, ID2 is 4-cycloheptyl-3,6-dimethyl-1,2-phenylene dibenzoate:

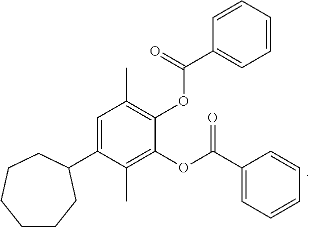 [SMILES: Cc1cc(C2CCCCCC2)c(C)c(OC(=O)c2ccccc2)c1OC(=O)c1ccccc1]

The catalyst component used in this example, exhibits an average particle size (62.8 microns), high activity (103.6 kg/g), and high hydrogen response (MFR=655.6 g/10 min at 35 SL).

Example 4. Example 3 was repeated except ID3 was used and the solid precipitate was treated with 10% TiCl₄ in toluene at 110° C. for 1 hour. ID3 is 1,1′-[5-(1,1-dimethylethyl)-3-methyl-1,2-phenylene]bis(3-chlorobenzoate):

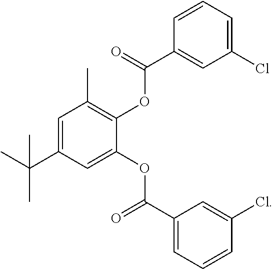 [SMILES: Cc1cc(C(C)(C)C)cc(OC(=O)c2cccc(Cl)c2)c1OC(=O)c1cccc(Cl)c1]

The catalyst component exhibited an average particle size of about 10.8 microns

Example 5. Example 4 was repeated using ID4, 3,6-dimethyl-1,2-phenylene dibenzoate:

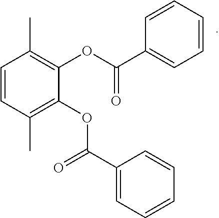 [SMILES: Cc1ccc(C)c(OC(=O)c2ccccc2)c1OC(=O)c1ccccc1]

The catalyst component exhibited an average particle size of 21 microns and the catalyst component produces polypropylene (PP) with a high melt flow rate (MFR) of 342 g/10 min at 35 SL.

Example 6. Example 4 was repeated except ID5 was used. The produced catalyst component particles were, on average, 16.9 microns, and the catalyst component produces PP with high MFR (582.7 g/10 min at 35 SL). ID5 is 5-(tert-butyl)-3-methyl-1,2-phenylene diphenyl bis(carbonate):

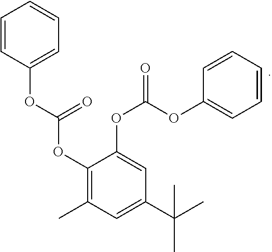 [SMILES: Cc1cc(C(C)(C)C)cc(OC(=O)Oc2ccccc2)c1OC(=O)Oc1ccccc1]

The following Examples 7 and 8 describe the catalyst component preparation with ID 1 and a polyacrylate compound (Viscoplex®-154). Addition of the polyacrylate compound in the reaction mixture prior to TiCl₄ addition results in a reduction of particle size of the catalyst component and in increased tacticity of the produced catalysts. Example 8 incorporates additional treatment of the catalyst component with TiCl₄/toluene (10% vol) which results in increasing the catalyst activity and catalyst tactisity in comparison with Example 7.

Example 7. Example 1 was repeated except 0.5 g of Viscoplex-126 was added after ID1 was added. The catalyst demonstrates activity of 52.6 kg/g and produces PP with XS=3.39%

Example 8. Example 2 was repeated except 0.5 g of Viscoplex-126 was added after ID1 was added. The catalyst demonstrates activity of 77.6 kg/g and produces PP with XS=2.66%.

Example 9. Example 8 was repeated except 1.25 g of ID1 and 0.25 g of Viscoplex-126 was added to the reaction mixture prior to addition of TiCl₄, and 0.5 g of ID1 was added during the TiCl₄/toluene treatment at 105° C.

This describes the catalyst component preparation with two placements of the internal donor ID1: (1) at addition of ID1 in the reaction mixture before the precipitate formed and (2) addition of ID1 after the precipitate formed. The result demonstrates increasing catalyst activity, catalyst tacticity, and polymer morphology (bulk density).

Example 10. 3.3 g MgCl₂, 0.25 g Al(O-iPr)₃, 20 g toluene, 9.1 g of TBP, 1.0 g Syltherm™ (polydimethylsiloxane; “PDMS”), and 3.55 g of ECH were charged to the reactor. The mixture was heated to 60° C. and held for 8 hours at 600 RPM agitation speed, followed by cooling to 25° C. Then, 27 g toluene, 1.5 grams of TEOS in 3 g of toluene, and 2.66 g of ID6 (24% solution) were added to the reactor. The reactor was chilled to −25° C. and 65.4 g of TiCl₄ was added to the reactor. The agitation was set to 300 RPM. The reaction mixture was heated to 35° C. over 2 hours, and then held for 30 minutes at temperature with stirring. The reaction was then further heated to 85° C. and held for 30 minutes. A solid product precipitated and after decantation of the supernate, 50 mL of toluene was added. The reactor was heated to 40° C. at 400 RPM and 2.66 g of ID6 (24% solution) was added. The reactor was further heated to 105° C. and was held for 1 hour, then allowed to settle and decanted. The solid was treated with 65 mL of 10% TiCl₄ at 105° C., and with 65 mL of 10% TiCl₄ at 110° C. for 1 hour. The final solid was collected and washed with hexane before drying. The ID6 is (1,1′-[5-(1,1-dimethylethyl)-3-methyl-1,2-phenylene]dibenzoate):

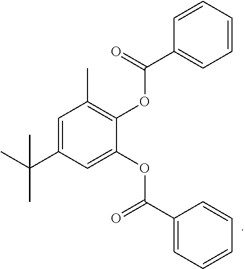 [SMILES: Cc1cc(C(C)(C)C)cc(OC(=O)c2ccccc2)c1OC(=O)c1ccccc1]

The internal donor was added before the precipitation and after when the precipitation is completed. The catalyst demonstrates high activity (91.2 kg/g) and produces PP with high bulk density (0.443 g/cc).

Example 11. Example 10 was repeated except internal donor ID1 (0.791 g), TEOS (0.500 g) and Viscoplex®-261 (0.500 g) were added prior to TiCl₄ addition.

Example 12. Example 11 was repeated without TiCl₄/toluene treatment at 105 and 110° C.

Example 13. Example 10 was repeated except ID1 (1.00 g) and TEOS (0.750 g) were used without the precipitate treatment at 105 and 110° C.

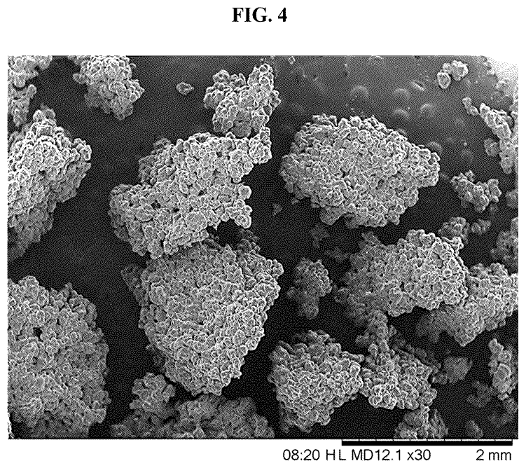

Example 14 (Comparative). Example 2 was repeated without the addition of internal donor ID2 in the precipitation step. Instead, the internal donor (ID6, 0.66 g) was added to the solid support during the 10% TiCl₄/toluene treatment. This Comparative Example demonstrates the preparation of the catalyst component without addition of the internal donor in the precipitation step. The corresponding catalysts produce PP particles with irregular morphology and low bulk density (0.237 g/cc). See FIG. 4.

Example 15 (Comparative). Comparative example 1 was repeated, except phthalic anhydride (PA, 0.60 g) was added the homogeneous solution. The Comparative Example demonstrates the preparation of the catalyst component with PA as a surfactant. The catalyst component contains phthalate impurities diisopropylchlorophthalate (DICPP) (1.23%), phthaloyl chloride (PhCl) (0.35%).

Example 16. Testing. The solid catalyst components or the solid precipitates can be used for ethylene polymerization process. Table 1 demonstrates catalyst activity and polyethylene properties produced with solid precipitate from examples 10-13. The polymerization was conducted in hexane in a one-gallon reactor. The reactor was purged at 100° C. under nitrogen for one hour. At room temperature, 0.6 ml of 25-wt % triethylaluminum (TEAL) in heptane was added into the reactor. Then 1500 ml of hexane was added and 10 mg of the catalyst prepared above were added into the reactor. The reactor was pressurized with H₂ (6 SL or 30 SL) then charged with ethylene to 116 psig. The reactor was heated to, and held, at 80° C. for two hours. At the end of the hold, the reactor was vented and the polymer was recovered.

TABLE 1
Ethylene Polymerization data (Example 16)

| Catalyst | H₂ (#, SL) | CE, kg/g | B/D, g/cc | MI | MI10 | HLMI | RATIO | D50, μ | SPAN |
|---|---|---|---|---|---|---|---|---|---|
| 11 | 6 | 19.4 | 0.259 | 0.845 | 7.820 | 29.253 | 34.619 | 319 | 0.550 |
| 11 | 30 | 13.2 | 0.196 | 32.780 | 299.612 | 433.838 | 13.235 | 290 | 0.593 |
| 12 | 6 | 23.8 | 0.232 | 1.573 | 14.774 | 56.139 | 35.689 | 391 | 0.694 |
| 12 | 30 | 30.3 | 0.246 | 47.404 | 431.537 | 448.798 | 9.468 | 374 | 0.985 |
| 10 | 6 | 19.0 | 0.282 | 1.135 | 11.537 | 44.670 | 39.357 | 241 | 1.060 |
| 10 | 30 | 4.6 | 0.250 | 21.715 | 186.999 | 416.618 | 19.186 | 248 | 0.808 |
| 13 | 6 | 27.5 | 0.195 | 1.041 | 12.313 | 47.034 | 45.182 | 834 | 0.785 |
| 13 | 30 | 22.3 | 0.172 | 40.693 | 363.146 | 457.635 | 11.246 | 599 | 1.104 |

Examples 1-6 demonstrate the catalyst component preparation with different internal donors and the catalyst behavior in propylene polymerization. The examples show the effect of an internal donor on the catalyst morphology (catalyst particle size) and the catalyst performance (Table 2; catalyst activity, catalyst tacticity and hydrogen response).

TABLE 2
Characterization of catalyst components prepared with different internal donors and bulk propylene polymerization data

| | Internal donor, | | | | | | | | | | | |
|---|---|---|---|---|---|---|---|---|---|---|---|---|
| | (ID wt/ | | | Ti | Mg | D | CE | MFR, | XS, | BD, | PP | PP |
| Example | MgCl₂ wt) | D50, μ | Span | % | % | % | kg/g | g/10 min | % | g/cc | D50, μ | Span |
| 1 | ID 1 (0.34) | N/A | N/A | 4.56 | 14.21 | 18.0 | 64.2 | 2.88 | 3.65 | 0.429 | 924 | 0.621 |
| 2 | ID 1 (0.34) | 18.0 | 0.834 | 5.59 | 14.32 | 20.3 | 78.6 | 1.74 | 4.48 | 0.373 | 1165 | 1.000 |
| 3 | ID 1 (0.34) | 62.8 | 0.729 | 6.63 | 14.67 | 15.7 | 103.6 | 9.5 | 4.03 | 0.348 | 2728 | 0.880 |
| | | | | | | | | (655.6*) | | | | |
| 4 | ID 2 (0.34) | 10.8 | 0.835 | 6.10 | 13.42 | 10.3 | 76.2 | 6.5 | 5.01 | 0.380 | 560 | 1.272 |
| 5 | ID 3 (0.34) | 21.4 | 0.866 | 6.98 | 12.89 | 6.3 | 45.2 | 28.6 | 5.22 | 0.309 | 862 | 0.823 |
| | | | | | | | | (342.0*) | | | | |
| 6 | ID 4 (0.34) | 16.9 | 0.721 | 3.90 | 16.07 | | 38.3 | 33.2 | 2.37 | 0.400 | 602 | 1.312 |
| | | | | | | | | (582.7*) | | | | |

*MFR at polymerization with H₂ = 35 SL

TABLE 3
Characterization of catalyst components prepared with internal donors and other additives and bulk propylene polymerization data

| | | Other | | | | | | | | | | | |
|---|---|---|---|---|---|---|---|---|---|---|---|---|---|
| | Internal donor, | additives | | | Ti | Mg | D | CE | MFR, | XS, | BD, | PP | PP |
| Example | (ID/MgCl₂ wt) | (wt/MgCl₂) | D50, μ | Span | % | % | % | kg/g | g/10 min | % | g/cc | D50, μ | Span |
| 7 | ID 1 (0.34) | Viscoplex | n/a | n/a | 4.30 | 13.06 | 18.6 | 52.6 | 2.25 | 3.39 | 0.389 | 504 | 2.100 |
| | | (0.15) | | | | | | | | | | | |
| 8 | ID 1 (0.34) | Viscoplex | 8.5 | 0.920 | | | 19.2 | 77.6 | 1.32 | 2.66 | 0.385 | 1153 | 1.00 |
| | | (0.15) | | | | | | | | | | | |
| 9 | ID 1 | Viscoplex | 11.7 | 0.662 | 3.24 | 13.27 | 23.7 | 82.4 | 0.98 | 1.91 | 0.448 | 549 | 0.812 |
| | (0.38 + 0.15) | (0.07) | | | | | | | | | | | |
| 10 | ID 6 | Sylterm | 8.9 | 0.982 | 3.94 | 15.76 | 17.1 | 91.2 | 0.25 | 1.9 | 0.443 | 495 | 1.204 |
| | (0.19 + 0.19) | (0.07), TEOS | | | | | | | | | | | |
| | | (0.45) | | | | | | | | | | | |
| 11 | ID 1 (0.24) | Syltherm | 10.9 | 0.834 | 6.50 | 13.54 | 12.2 | 68.0 | 2.71 | 4.48 | N/A | N/A | N/A |
| | | (0.30), TEOS | | | | | | | | | | | |
| | | (0.15), | | | | | | | | | | | |
| | | Viscoplex | | | | | | | | | | | |
| | | (0.15) | | | | | | | | | | | |
| 14 | ID6 | | 7.12 | 1,356 | 2.82 | 18.48 | 7.41 | 51.4 | 2.86 | 4.07 | 0.237 | 1393 | 1,057 |
| (Comp.) | | | | | | | | | | | | | |
| 15 | ID 6 | PA | 14.0 | 1.067 | 2.28 | 19.29 | 9.26 | 65.7 | 2.86 | 0.20 | 0.417 | 486 | 1.749 |
| (Comp.) | | | | | | | | | | | | | |

### Abbreviations and Definitions

“D₁₀” represents the size of particles (diameter), wherein 10% of particles are less than that size, “D₅₀” represents the size of particles, wherein 50% of particles are less than that size, and “D₉₀” represents the size of particles, wherein 90% of particles are less than that size.

“Span” represents the distribution of the particle sizes of the particles. The value can be calculated according to the following formula:

$$Span = ( {D}_{90} - {D}_{10} ) / {D}_{50} .$$

“PP” prior to any D or Span value indicates the D value or Span value for polypropylene prepared using the catalysts indicated.

“BD” is an abbreviation for bulk density, and is reported in units of g/ml.

“CE” is an abbreviation for catalyst efficiency and is reported in units of Kg polymer per gram of catalyst (Kg/g) during the polymerization for 1 hour.

“MFR” is an abbreviation for melt flow rate and is reported in units of g/10 min (unless otherwise indicated). The MFR is measured cording to ASTM standard D1238.T

SYLTHERM® is a tradename for a polydimethyl siloxane (PDMS) that is commercially available from Dow Chemical.

VISCOPLEX® is a tradename for a polyalkyl methacrylate available from Evonik.

EB is an abbreviation for ethyl benzoate.

TBP is an abbreviation for tributyl phosphate.

ECH is an abbreviation for epichlorohydrin.

TEOS is an abbreviation for tetraethylorthosilicate.

XS is an abbreviation for xylene solubles, and is reported in units of wt % (unless otherwise indicated).

While certain embodiments have been illustrated and described, it should be understood that changes and modifications may be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations may be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range may be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like, include the number recited and refer to ranges which may be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A process of preparing a solid catalyst component for olefin polymerization, the process comprising:
forming a magnesium solution by a reaction of a halide-containing magnesium compound with an epoxy compound in a hydrocarbon solvent;
adding at least one non-phthalate internal donor to the magnesium solution to form a first mixture;
treating the first mixture with a first titanium compound to form a solid precipitate; and
separating the solid precipitate from the first mixture to form the solid catalyst component.

2. The process of claim 1, wherein the treating further comprises treating the solid precipitate with a second titanium compound to form the solid catalyst component.

3. The process of claim 1, wherein the treating further comprises treating the solid precipitate with a second titanium compound and a second internal electron donor to form the solid catalyst component.

4. The process of claim 1, wherein the magnesium solution further comprises an organosilicon compound.

5. The process of claim 4, wherein the organosilicon compound is represented as RₙSi(OR′)₄₋ₙ, wherein R is alkyl, or aryl; R′ is alkyl or aryl.

6. The process of claim 4, wherein the organosilicon is a polysiloxane.

7. The process of claim 1, wherein the magnesium solution further comprises a halogenating agent containing at least one halogen atom capable of transfer to the magnesium.

8. The process of claim 7, wherein the halogenating agent is an aryloyl chloride, a alkanoyl chloride, an alkyl chloride, HCl, TiCl₄, RₙTiCl₄₋ₙ, CCl₄, RₙSiCl₄₋ₙ, and RₙA1C1₃₋ₙ, wherein R represents alkyl, cycloalkyl, aryl, or alkoxy, and n is a whole number satisfying the formula 0<n<4 and a ratio of the halogenating agent to the magnesium compound is at least 1:1 on a mol basis.

9. The process of claim 1, wherein the magnesium solution further comprises an organic phosphorus compound.

10. The process of claim 1, wherein the magnesium solution further comprises an organosilicon compound, a polyacrylate, an organic phosphorus compound, or a mixture of any two or more thereof.

11. The process of claim 2, wherein the first and second (if present) titanium compound is represented by:
Ti(OR)_{g}X_{4-g};
wherein:
each R is independently a C₁-C₂₀ alkyl, a C₃-C₂₀ cycloalkyl, or C₆-C₃₀ aryl;
X is Br, Cl, or I; and
g is 0, 1, 2, 3, or 4.

12. The process of claim 1, wherein the solid catalyst component exhibits an average particle size of about 3 microns to about 100 microns (on a 50% by volume basis).

13. The process of claim 1, wherein the internal electron donor is represented as: 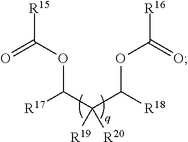
wherein:
each of R¹⁵ through R²⁰ are independently H, a heteroatom, alkyl, cycloalkyl, cycloalkylalkyl, aryl, aralkyl, heterocyclyl, heterocyclylalkyl, heteroaryl, or heteroarylalkyl; and
q is an integer from 0 to 12.

14. The process of claim 1, wherein the internal electron donor is represented by one of the following formulae: 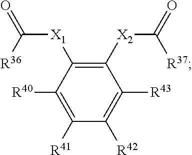
wherein:
R⁴⁰-R⁴³ are each independently selected from H, a heteroatom, alkyl, cycloalkyl, cycloalkylalkyl, aryl, aralkyl, alkylaryl, or an —OR⁴⁴; where R⁴⁴ is C₁-C₂₀ alkyl, C₆-C₂₀ aryl, C₆-C₂₀ aralkyl, or C₆-C₂₀ alkylaryl;
R³⁶ and R³⁷ are each independently selected from F, Cl, Br, I, alkyl, cycloalkyl, cycloalkylalkyl, aryl, aralkyl, alkylaryl, —OR⁴⁵, or —NR₂⁴⁶;
R⁴⁵ is C₁-C₂₀ alkyl, C₆-C₂₀ aryl, or alkylaryl;
X₁ and X₂ are each O, S, or NR⁴⁷; and
R⁴⁷ is H, C₁-C₂₀ alkyl, C₆-C₂₀ aryl, C₆-C₂₀ aralkyl; or 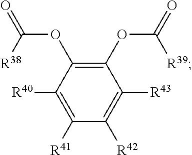
wherein: R³⁸, R³⁹, R⁴⁰, R⁴¹, R⁴², and R⁴³ are each independently H, a heteroatom, alkyl, cycloalkyl, cycloalkylalkyl, aryl, alkylaryl, heterocyclyl, heterocyclylalkyl, heteroaryl, or heteroarylalkyl; or 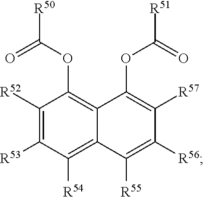
wherein: each of R⁵⁰ through R⁵⁷ are each independently H, a heteroatom, alkyl, cycloalkyl, cycloalkylalkyl, aryl, aralkyl, heterocyclyl, heterocyclylalkyl, heterocyclic alkyl or aryl, heteroaryl, or heteroarylalkyl.

15. A solid catalyst component for olefin polymerization, the solid catalyst component comprising a halide-containing magnesium, a titanium compound, and an internal electron donor;
wherein:
the solid catalyst component is prepared from a homogenous reaction mixture containing the halide-containing magnesium, an epoxy compound, and the internal electron donor, wherein a titanium halide is added to the mixture to form the solid catalyst component;
the halide-containing magnesium is represented by:
Mg(OR′)ₓX′₂₋ₓ;
each R′ is independently a C₁-C₂₀ alkyl optionally substituted with a halogen, or a C₃-C₂₀ cycloalkyl alkyl optionally substituted with a halogen;
X′ is Br, Cl, or I;
x is 0, 1 or 2;
the internal electron donor is a non-phthalate internal electron donor;
the internal electron donor is present from about 3 wt % to about 25 wt % based upon the total solids weight of the solid catalyst component;
the titanium compound is represented by:
Ti(OR)_{g}X_{4-g};
each R is independently a C₁-C₂₀ alkyl, a C₃-C₂₀ cycloalkyl, or a C₆-C₃₀ aryl;
X is Br, Cl, or I;
g is 0, 1, 2, 3, or 4;
the titanium is present from 1 wt % to about 6 wt % based upon the total solids weight of the solid catalyst component; and
the solid catalyst component has a particle size from about 3 microns to about 100 microns (on a 50% by volume basis).

16. A catalyst system for use in olefinic polymerization, the catalyst system comprising the solid catalyst component produced by the process of claim 1, an organoaluminum compound, and optionally, an organosilicon compound and/or organic external donor compound comprising an oxygen or a nitrogen atom.

17. The catalyst system of claim 16, wherein the organoaluminum compound is an alkyl-aluminum compound.

18. The catalyst system of claim 17, wherein the alkyl-aluminum compound is a trialkyl aluminum compound.

19. The catalyst system of claim 18, wherein the trialkyl aluminum compound comprises triethylaluminum, triisobutylaluminum, or tri-n-octylaluminum.

20. A process for polymerizing or copolymerizing an olefinic monomer, the process comprising contacting an olefinic monomer with the catalyst system of claim 16 to form a polyolefin polymer.
